(19) United States
(12) Patent Application Publication
(10) Pub. No.: US 2013/0209920 A1
(43) Pub. Date: Aug. 15, 2013

(54) POWDERED GRIT MADE OF A FUSED CERMET

(71) Applicants: Samuel Marlin, Plan D'Orgon (FR); Victor Orera Clemente, Zaragoza (ES); José Pena Torre, Zaragoza (ES); Miguel Angel Laguna Bercero, Zaragoza (ES); Angel Larrea Arbaizar, Zaragoza (ES); Rosa Merino Rubio, Zaragoza (ES)

(72) Inventors: Samuel Marlin, Plan D'Orgon (FR); Victor Orera Clemente, Zaragoza (ES); José Pena Torre, Zaragoza (ES); Miguel Angel Laguna Bercero, Zaragoza (ES); Angel Larrea Arbaizar, Zaragoza (ES); Rosa Merino Rubio, Zaragoza (ES)

(73) Assignees: SAINT-GOBAIN CENTRE DE RECHERCHES ET D'ETUDES EUROPEEN, Courbevoie (FR); CONSEJO SUPERIOR DE INVESTIGACIONES CIENTIFICAS, Madrid (ES)

(21) Appl. No.: 13/820,410

(22) PCT Filed: Sep. 14, 2011
(86) PCT No.: PCT/IB11/54010

§ 371 Date: Apr. 29, 2013

(30) Foreign Application Priority Data
Sep. 14, 2010 (FR) 1057339

(51) Int. Cl. H01M 4/90; B02C 19/00

(52) U.S. Cl. CPC H01M 4/9025; B02C 19/00
USPC 429/527; 429/528; 241/3

(57) ABSTRACT

Powdered grit comprising a fused cermet of zirconium oxide (ZrO₂) doped with a dopant chosen from yttrium, scandium, and a mixture of scandium and of aluminium and/or of cerium, and of nickel (Ni) and/or of cobalt (Co), said cermet having a eutectic structure, the contents, in mol %, of zirconium oxide, nickel and cobalt being such that 0.250Ni+0.176Co≦(ZrO₂+dopant)≦0.428Ni+0.333Co, and said powdered grit having a median diameter D₅₀ of between 0.3 μm and 100 μm.

### TECHNICAL FIELD

The present invention relates to a fused cermet powder, in particular for manufacturing an element of a solid-oxide fuel cell (SOFC) stack and especially an anode of such a cell stack. The invention also relates to a fused cermet precursor powder and to processes for the manufacture of said fused cermet powder and fused cermet precursor powder.

### STATE OF THE ART

An example of a solid-oxide fuel cell (SOFC) stack 10, manufactured by a hot pressing process, is represented diagrammatically in cross section in FIG. 1. The cell stack 10 comprises first and second elementary cells 12 and 14 respectively, separated by an interconnector layer 16. As the first and second elementary cells are similar in structure, only the first elementary cell 12 is described. The first elementary cell 12 successively comprises an anode 18, an electrolyte layer 20 and a cathode 22. The anode 18 is composed of an anode functional layer (AFL) 24, in contact with the electrolyte layer 20, and an anode support layer 26. The anode 18 is generally manufactured by a process consisting in depositing an anode functional layer 24 on the anode support layer 26, for example by screen printing. At this stage, the layers 24 and 26 can be based on precursor of the final anode material. A consolidation by sintering is subsequently carried out.

Fuel cell stacks or materials which can be used for the manufacture of fuel cell stacks are described, for example, in WO 2004/093235, EP 1 796 191, US 2007/0082254, EP 1 598 892 or EP 0 568 281.

Porous cermets formed of yttria-stabilized zirconia and nickel (Ni-YSZ) are commonly used to manufacture the anode functional layer. These cermets have in particular been studied in the paper entitled “Stability of Channeled Ni-YSZ Cermets Produced from Self-assembled NiO-YSZ Directionally Solidified Eutectics”, in J. Am. Ceram. Soc., 88 (2005), pages 3215/3217. This paper describes a porous plate made of a Ni-YSZ cermet intended for the manufacture of a solid-oxide fuel cell stack anode. This cermet exhibits a regular lamellar eutectic structure, resulting from the use of a laser floating-zone melting method. The lamellar eutectic structure makes it possible to form parallel channels for the movement of gas, electron transportation and the diffusion of oxygen ions (abstract and conclusion). This regular lamellar eutectic structure is thus advantageous in the manufacture of electrodes of SOFC cell stacks, in particular in comparison with the cermet electrodes used previously which are conventionally obtained by sintering powders formed of yttrified zirconia and nickel oxide or by sintering powders formed of zirconia, yttria and nickel oxide.

The paper also explains (“Experimental Procedure” section) that samples in the form of bars were used to facilitate the experimentation, as during the study commented on in the paper “Structured porous Ni-and Co-YSZ cermets fabricated from directionally solidified eutectic composites”, Journal of the European Ceramic Society, 25 (2005), pages 1455-1462, commented on below. However, the plate form is the form appropriate for flat SOFC cell stacks.

In addition to Ni-YSZ cermets, the paper “Structured porous Ni-and Co-YSZ cermets fabricated from directionally solidified eutectic composites” also studies Co-YSZ cermets having a lamellar eutectic structure (in the form of monolithic bars). As is indicated in the introduction of this document, it is known that Co-YSZ cermets are appropriate materials for the manufacture of SOFC cell stack anodes. The ceramic is then manufactured with fine and homogeneous powders in order to increase the number of triple phase points (TPB). However, the coalescence of the grains at the operating temperatures (600-1000° C.) presents difficulties with these “dispersed” electrodes. The use of bulk lamellar electrodes has thus been proposed in order to solve these problems.

In order to limit the risk of cracking, which is extremely harmful in the applications targeted, this paper recommends process parameters which result in the manufacture of bars exhibiting a homogeneous lamellar eutectic structure: porous Ni or Co lamellae acting as electron conductor are supported by a lamellar YSZ network acting as ion conductor (conclusion).

In the abovementioned articles, the regular lamellar eutectic structure of the Ni-YSZ and Co-YSZ cermets is thus described as advantageous in channeling the electron conduction and the ion conduction. These cermets are thus regarded as highly promising in the manufacture of functional “layers” or as substrates for “film-shaped” electrodes (conclusions of the papers).

However, the production of a lamellar eutectic structure results from the controlled movement of a solidification front, which limits the shapes of the products which it is possible to manufacture.

Furthermore, the performance of SOFC cell stacks can change over time, in particular under the effect of the aging of the anodes. This aging can result in a decrease in the lifetime of the cell stacks.

There thus exists a need for a novel material suitable for the manufacture of SOFC cell stack anodes which exhibit a long lifetime and which are capable of exhibiting varied shapes. One aim of the invention is to meet this need.

### SUMMARY OF THE INVENTION

According to the invention, this aim is achieved by means of a powder formed of fused grains, said grains, referred to as “cermet grains”, comprising a fused cermet
formed of zirconium oxide ZrO₂ doped with a dopant chosen from yttrium, scandium, and mixtures of scandium and of aluminum and/or of cerium, and
of nickel Ni and/or of cobalt Co,
   said cermet exhibiting a eutectic structure,
   said powder exhibiting a median diameter D₅₀ of between 0.3 μm and 100 μm.

As will be seen in more detail in the continuation of the description, such a powder, referred to as “cermet powder”, makes it possible to manufacture, by shaping and then sintering, a sintered body and in particular an anode suitable for SOFC fuel cell stacks. Advantageously, this process makes it possible to manufacture sintered bodies of varied shapes.

The grinding of the fused bulk bodies described in the abovementioned papers makes it possible to manufacture powders according to the invention. By sintering these powders, the inventors have reconstructed bodies which remain highly suitable for the manufacture of anodes, although the grinding and then the shaping obviously resulted in a structure completely different from that of the original bulk bodies. This result is surprising insofar as it might have been expected that the disorganization of the structure resulting from the grinding and from the sintering would greatly damage the performance. It remains unexplained to date by the inventors.

The use of a cermet powder according to the invention also makes it possible to overcome, at least partially, the cracking problems described above.

Furthermore, surprisingly, the inventors have discovered that the material of the fused grains of a cermet powder according to the invention exhibits a particularly high stability of the porosity over time, in particular in an application in SOFC cell stacks. This advantageously results in a stability in the performance of said cell stacks and thus in a greater lifetime.

Finally, the use of a cermet powder according to the invention to manufacture a sintered body makes it possible to create an additional porosity in this body and to regulate this additional porosity, in particular by adjusting the particle size distribution of the powder.

A cermet powder according to the invention can also comprise one or more of the following optional characteristics:
the contents of zirconium oxide, of dopant, of nickel and of cobalt, as molar percentages on the basis of the total molar amount of zirconium oxide, of dopant, of nickel and of cobalt, are such that:

0.250×Ni+0.176×Co≦(ZrO₂+dopant)≦0.428×Ni+0.333×Co;
preferably, a cermet powder according to the invention comprises more than 70%, more than 80%, more than 90%, more than 95%, more than 98%, indeed even substantially 100%, of cermet grains, as percentage by weight;
a cermet powder according to the invention exhibits a content of impurities of less than 5% by weight, preferably of less than 2% by weight and more preferably of less than 1% by weight.

Said cermet grains can also comprise one or more (insofar as they are not incompatible) of the following optional characteristics:
the cermet grains preferably comprise more than 80%, more than 90%, more than 95%, indeed even substantially 100%, of said cermet, as percentage by weight; the remainder to 100% is preferably composed of impurities and of nickel oxide and/or of cobalt oxide, preferably in molar proportions such that: 0.250×NiO+0.176×CoO≦(ZrO₂+dopant)≦0.428×NiO+0.333×CoO, as molar percentages on the basis of the total molar amount of zirconium oxide, of dopant, of nickel oxide and of cobalt oxide, not taking into consideration the zirconium oxide and the dopant in cermet form; preferably, when the cermet does not comprise Ni, the remainder to 100% does not comprise NiO; preferably, when the cermet does not comprise Co, the remainder to 100% does not comprise CoO;
preferably, the cermet grains are composed, for more than 80%, more than 90%, more than 95%, indeed even substantially 100% of their weight, of said cermet and of precursor of said cermet;
the zirconium oxide, the nickel, the cobalt and the dopant together represent more than 95%, more than 98%, more than 99%, indeed even substantially 100%, of the cermet, as molar percentage; preferably the remainder to 100% is composed of impurities;
the composition of the cermet is such that, as molar percentages on the basis of the total molar amount of zirconium oxide, of dopant, of nickel and of cobalt:

0.290×Ni+0.212×Co≦(ZrO₂+dopant)≦0.379×Ni+0.290×Co; preferably such that

0.307×Ni+0.227×Co≦(ZrO₂+dopant)≦0.360×Ni+0.273×Co;
the cermet comprises less than 1% of nickel, as molar percentage, preferably does not comprise nickel; preferably, the composition of the cermet is then such that, as molar percentages on the basis of the total molar amount of zirconium oxide, of dopant, of nickel and of cobalt:

0.176×Co≦(ZrO₂+dopant)≦0.333×Co;
the composition of the cermet is such that, as molar percentages, for a total, excluding impurities, of 100%,
   (ZrO₂+dopant): 15%-25%
   Co: 75%-85%;
preferably such that
   (ZrO₂+dopant): 17.5%-22.5%
   Co: 77.5%-82.5%;
preferably such that
   (ZrO₂+dopant): 18.5%-21.5%
   Co: 78.5%-81.5%;
preferably such that
   (ZrO₂+dopant): 20%
   Co: 80%;
the cermet comprises less than 1% of cobalt, as molar percentage, preferably does not comprise cobalt; preferably, the composition of the cermet is then such that, as molar percentages on the basis of the total molar amount of zirconium oxide, of dopant, of nickel and of cobalt:

0.250×Ni≦(ZrO₂+dopant)≦0.428×Ni;
the composition of the cermet is such that, as molar percentages, for a total, excluding impurities, of 100%,
   (ZrO₂+dopant): 20%-30%
   Ni: 70%-80%;
preferably such that
   (ZrO₂+dopant): 22.5%-27.5%
   Ni: 72.5%-77.5%;
preferably such that
   (ZrO₂+dopant): 23.5%-26.5%
   Ni: 73.5%-76.5%;
preferably such that
   (ZrO₂+dopant): 25%
   Ni: 75%;
the molar content of dopant of the zirconium oxide ZrO₂, on the basis of the sum of the contents of zirconium cations and of dopant cations, is greater than 14% and/or less than 25%;
more than 90%, more than 95%, indeed even substantially 100%, as molar percentage, of the zirconium oxide ZrO₂ is doped;
preferably, the zirconium oxide ZrO₂ is doped only with yttrium; the molar content of yttrium, on the basis of the sum of the molar contents of zirconium and of yttrium, is greater than 14%, preferably greater than 15%, and/or less than 22%, preferably less than 21%, preferably substantially equal to 16% or substantially equal to 20%;
the zirconium oxide ZrO₂ is doped only with scandium; the molar content of scandium, on the basis of the sum of the molar contents of zirconium and of scandium, is greater than 14% and/or less than 22%, preferably substantially equal to 20%;
the zirconium oxide ZrO₂ is doped only with a mixture of scandium, on the one hand, and of aluminum and/or of cerium, on the other hand;
the molar content of scandium, on the basis of the sum of the molar contents of zirconium, scandium, aluminum and cerium, is greater than 14% and/or less than 22%, preferably substantially equal to 20%;
the molar amount of aluminum, on the basis of the sum of the molar contents of zirconium, scandium, aluminum and cerium, is greater than 1% and/or less than 3%, preferably substantially equal to 2%;
the molar content of cerium, on the basis of the sum of the molar contents of zirconium, scandium, aluminum and cerium, is greater than 0.5% and/or less than 1.5%, preferably substantially equal to 1%.

The invention also relates to a powder formed of fused grains, referred to as “cermet precursor grains”, the composition of which is suitable for resulting, by reduction, in cermet grains according to the invention.

Such a powder formed of cermet precursor grains is referred to as “cermet precursor powder”.

Preferably, the cermet precursor powder exhibits a content of impurities of less than 5% by weight, preferably of less than 2% by weight and more preferably of less than 1% by weight.

The invention relates in particular to a cermet precursor powder comprising, indeed even consisting of, CoO-doped ZrO₂ grains and/or NiO-doped ZrO₂ grains, said grains exhibiting a lamellar eutectic structure.

The invention relates in particular to a powder formed of fused grains, said grains comprising:
zirconium oxide ZrO₂ doped with a dopant chosen from yttrium, scandium, and mixtures of scandium and of aluminum and/or of cerium,
less than 5% by weight of impurities, and
as remainder to 100% by weight, nickel oxide NiO and/or cobalt oxide CoO, the contents of zirconium oxide, of dopant, of nickel oxide and of cobalt oxide, as molar percentages, expressed on the basis of the total molar amount of zirconium oxide, of dopant, of nickel oxide and of cobalt oxide, being such that:

0.250×NiO+0.176×CoO≦(ZrO₂+dopant)≦0.428×NiO+0.333×CoO.

This powder makes it possible to manufacture, via a reduction operation, a cermet powder according to the invention.

A cermet precursor grain according to the invention can exhibit one or more of the following optional characteristics:
said cermet precursor grains preferably comprise more than 80%, more than 90%, more than 95%, indeed even substantially 100%, of said cermet precursor, as percentage by weight;
preferably, a cermet precursor powder according to the invention comprises more than 70%, more than 80%, more than 90%, more than 95%, more than 98%, indeed even substantially 100%, of cermet precursor grains, as percentage by weight;
the composition of the cermet precursor grains is such that, as molar percentages, expressed on the basis of the total molar amount of zirconium oxide, of dopant, of nickel oxide and of cobalt oxide:

0.290×NiO+0.212×CoO≦(ZrO₂+dopant)≦0.379×NiO+0.290×CoO;

preferably, 0.307×NiO+0.227×CoO≦(ZrO₂+dopant)≦0.360×NiO+0.273×CoO;
the cermet precursor comprises less than 1% of nickel oxide, preferably does not comprise nickel oxide; the composition of the cermet precursor grains is then such that, as molar percentages, expressed on the basis of the total molar amount of zirconium oxide, of dopant, of nickel oxide and of cobalt oxide:

0.176×CoO≦(ZrO₂+dopant)≦0.333×CoO;
the composition of the cermet precursor is such that, as molar percentages, for a total, excluding impurities, of 100%,
   (ZrO₂+dopant): 15%-25%
   CoO: 75%-85%;
preferably such that
   (ZrO₂+dopant): 17.5%-22.5%
   CoO: 77.5%-82.5%;
preferably such that
   (ZrO₂+dopant): 18.5%-21.5%
   CoO: 78.5%-81.5%;
preferably such that
   (ZrO₂+dopant): 20%
   CoO: 80%;
the cermet precursor comprises less than 1% of cobalt oxide, preferably does not comprise cobalt oxide; the composition of the cermet precursor grains is then such that, as molar percentages, expressed on the basis of the total molar amount of zirconium oxide, of dopant, of nickel oxide and of cobalt oxide:

0.250×NiO≦(ZrO₂+dopant)≦0.428×NiO;
the composition of the cermet precursor is such that, as molar percentages, for a total, excluding impurities, of 100%,
   (ZrO₂+dopant): 20%-30%
   NiO: 70%-80%;
preferably such that
   (ZrO₂+dopant): 22.5%-27.5%
   NiO: 72.5%-77.5%;
preferably such that
   (ZrO₂+dopant): 23.5%-26.5%
   NiO: 73.5%-76.5%;
the cermet precursor exhibits the following molar composition, corresponding to the eutectic:
   (ZrO₂+dopant): 25%
   NiO: 75%;
the molar content of dopant of the zirconium oxide ZrO₂, on the basis of the sum of the contents of zirconium cations and of dopant cations, is greater than 14% and/or less than 25%;
more than 90%, more than 95%, indeed even substantially 100%, as molar percentage, of the zirconium oxide ZrO₂ is doped;
preferably, the zirconium oxide ZrO₂ is doped only with yttrium; the molar content of yttrium, on the basis of the sum of the molar contents of zirconium and of yttrium, is greater than 14%, preferably greater than 15%, and/or less than 22%, preferably less than 21%, preferably substantially equal to 16% or substantially equal to 20%;
the zirconium oxide ZrO₂ is doped only with scandium;
the molar content of scandium, on the basis of the sum of the molar contents of zirconium and of scandium, is greater than 14% and/or less than 22%, preferably substantially equal to 20%;
the zirconium oxide ZrO₂ is doped only with a mixture of scandium, on the one hand, and of aluminum and/or of cerium, on the other hand;
   the molar content of scandium, on the basis of the sum of the molar contents of zirconium, scandium, aluminum and cerium, is greater than 14% and/or less than 22%, preferably substantially equal to 20%;
   the molar content of aluminum, on the basis of the sum of the molar contents of zirconium, scandium, aluminum and cerium, is greater than 1% and/or less than 3%, preferably substantially equal to 2%;
   the molar content of cerium, on the basis of the sum of the molar contents of zirconium, scandium, aluminum and cerium, is greater than 0.5% and/or less than 1.5%, preferably substantially equal to 1%;
the zirconium oxide, the nickel oxide, the cobalt oxide and the dopant together represent more than 95%, more than 98%, more than 99%, indeed even substantially 100%, of the cermet precursor, as molar percentage.

A cermet grain or cermet precursor grain according to the invention preferably exhibits a lamellar structure. In the lamellar structure, the mean distance between two lamellae can in particular be greater than 0.2 μm, preferably greater than 0.3 μm, and/or less than 6 μm, preferably less than 4 μm.

A cermet powder or cermet precursor powder according to the invention can also comprise one or more of the following optional characteristics:
the median diameter D₅₀ is greater than 0.5 μm, indeed even greater than 1 μm, indeed even greater than 2 μm, and/or less than 80 μm, indeed even less than 50 μm, indeed even less than 40 μm;
in a first specific embodiment, the powder exhibits a median diameter of greater than 0.5 μm, indeed even of greater than 1 μm, and less than 4 μm. The characteristics of the anode functional layer of the SOFC cell stack are advantageously improved thereby;
in a second specific embodiment, the powder exhibits a median diameter of greater than 10 μm, indeed even of greater than 20 μm, and/or of less than 80 μm, indeed even of less than 50 μm, indeed even of less than 40 μm, indeed even of less than 30 μm; preferably, the median diameter is equal to approximately 25 μm; the characteristics of the anode support layer of the SOFC cell stack are advantageously improved thereby;
the 99.5 percentile, D_{99.5}, also known as “maximum size” of the grains of the powder, is less than 200 μm, indeed even less than 150 μm, indeed even less than 110 μm;
the distribution of the aspect ratio R of the powder is such that, the aspect ratio of a grain being the ratio L/W between the length L and the width W of said grain:
   less than 90%, indeed even less than 80%, of the grains of the powder exhibit an aspect ratio R of greater than 1.5, and/or
   at least 10%, indeed even at least 20%, and/or less than 60%, indeed even less than 40%, of the grains of the powder exhibit an aspect ratio R of greater than 2, and/or
   at least 5%, indeed even at least 10%, and/or less than 40%, indeed even less than 20%, of the grains of the powder exhibit an aspect ratio R of greater than 2.5, and/or
   at least 2%, indeed even at least 5%, and/or less than 20%, indeed even less than 10%, of the grains of the powder exhibit an aspect ratio R of greater than 3, the percentages being percentages by number;
the cermet grains and/or cermet precursor grains exhibit a regular structure without favored general orientation;
the cermet grains and/or cermet precursor grains are ground grains, that is to say grains resulting from a grinding operation on a fused product, for example in the form of particles or of blocks. Such a grinding confers a specific shape on the grains.

The invention also relates to a manufacturing process comprising the following successive stages:
a) mixing particulate starting materials introducing
   ZrO₂, CoO and/or NiO, and/or one or more precursors of these oxides, and
   a dopant for the zirconium oxide chosen from yttrium, scandium, mixtures of scandium, on the one hand, and of aluminum and/or of cerium, on the other hand, and/or one or more precursors of this dopant,
   to form a feedstock,
b) melting the feedstock until a molten material is obtained,
c) cooling until said molten material has completely solidified, so as to obtain a fused product,
d) grinding said fused product, so as to obtain a powder,
e) optionally reducing said powder, in order to increase the amount of CoO and/or NiO converted into Co and/or Ni,
   the starting materials being chosen and the cooling in stage c) comprising an operation in which the molten material and/or the fused product is brought into contact with a reducing fluid so that, on conclusion of stage d), the powder is a cermet powder according to the invention.

Preferably, the furnace used in stage b) is chosen from an induction furnace, a plasma torch, an arc furnace or a laser.

The present invention also relates to a sintered product obtained by sintering a cermet powder and/or cermet precursor powder according to the invention.

Preferably, a sintered product according to the invention exhibits a total porosity, preferably uniformly distributed, of greater than 20%, preferably of greater than 25%, preferably of greater than 30%.

Preferably, the cermet powder and/or cermet precursor powder according to the invention represents more than 80%, more than 90%, more than 95%, indeed even substantially 100%, of the weight of the sintered product.

The sintered product can in particular be all or part of an electrode, in particular an anode, in particular an anode functional layer. The invention also relates to such an anode and an elementary cell of a solid-oxide fuel cell stack comprising an electrode, in particular an anode, according to the invention, and to such a fuel cell stack.

### DEFINITIONS

The term “cermet” conventionally refers to a composite material comprising both a ceramic phase and a metal phase. The term “cermet precursor” refers to a material capable, under reducing conditions, of resulting in a cermet according to the invention. A cermet precursor generally comprises a ceramic phase and a phase of a precursor of a metal phase, that is to say capable of being converted into said metal phase under reducing conditions.

A product is conventionally said to be “fused” when it is obtained by a process which employs melting of starting materials and solidification by cooling.

The term “eutectic” conventionally describes a structure or a morphology obtained by melting a eutectic composition, followed by hardening of the molten material by cooling. The chapter “Solidification microstructure: Eutectic and peritectic” of the document “Fundamentals of Solidification”, third edition, W. Kurz and D. J. Fisher, Trans. Tech. Publication Ltd, Switzerland (1989), describes eutectic structures.

To the knowledge of the inventors, a melting stage is essential in order to obtain a eutectic structure.

It is also necessary, to obtain a eutectic structure, to use a eutectic composition. Such a composition only exists for certain combinations of oxides and, when it does exist, the proportions of the oxides depend on the oxides under consideration. Even if two eutectic compositions have one and the same oxide in common, the content of the other oxide which may make it possible to obtain a eutectic composition depends on the nature of this other oxide. For example, the eutectic compositions MgO—ZrO₂ and SrO—ZrO₂ are such that MgO/ZrO₂ is different from SrO/ZrO₂.

Thus, if a document describes a eutectic composition formed of two oxides and if changing one of these oxides is envisaged, there can be no assurance that a eutectic composition still exists with the new oxide, and even less is it possible a priori to determine the proportions which will make it possible to obtain such a eutectic composition.

A eutectic structure of a cermet precursor according to the invention can be of two types: regular (normal) or irregular (abnormal).

The regular structure of a cermet precursor according to the invention exhibits a lamellar growth morphology in which there exists a marked crystallographic relationship between the phases of the eutectic: more specifically, the lamellar morphology corresponds to a stacking of platelets, alternately made of zirconium oxide and of cobalt oxide or nickel oxide. During the solidification of the lamellae, the growth front D₁ (FIG. 6B)) moves along the plane of the lamellae.

A solidification rate of greater than 0.1 K/s, preferably of greater than 1 K/s, is preferable in order to obtain a regular eutectic structure. This is because the inventors have found that a solidification rate of less than 0.1 K/s promotes the sublimation of the oxide exhibiting the lowest melting point (CoO and/or NiO), it being possible for this sublimation to generate an irregular eutectic structure or a noneutectic structure.

The irregular eutectic structure does not exhibit any relationship between the orientation of the two phases (FIG. 6C) and 6D)).

By extension, the structure of a material resulting from a reduction of a cermet precursor exhibiting a eutectic structure is also described as a eutectic structure.

A “dopant” is a metal cation other than the zirconium cation, incorporated within the ZrO₂ crystal lattice, generally in solid solution. The dopant can be present as insertion and/or substitution cation within the zirconium oxide.

When zirconium oxide ZrO₂ is said to be “doped to x % with a dopant”, this conventionally means that, in said doped zirconium oxide, the amount of dopant is the molar percentage of doping cations on the basis of the total amount of doping cations and of zirconium cations. For example, in a zirconium oxide doped to 20 mol % with yttrium (Y), 20 mol % of the zirconium cations are replaced with yttrium cations. Likewise, in a zirconium oxide doped to 20 mol % with scandium (Sc) and 1 mol % with cerium, 21 mol % of the zirconium cations are replaced with 20 mol % of scandium cations and 1 mol % of cerium cations.

The term “(ZrO₂+dopant)” is understood to mean the sum of the molar contents of zirconium cations and of dopant cations.

A ZrO₂, CoO, NiO or dopant precursor is a compound capable of resulting in the formation of these oxides or of this dopant, respectively, by a process which comprises melting, followed by solidification by cooling. Zirconium oxide doped with a dopant or with an oxide of said dopant is a specific example of precursor of said dopant.

The term “size of a grain” is understood to mean the size of a grain conventionally given by a particle size distribution characterization carried out with a laser particle sizer. The laser particle sizer used here is a Partica LA-950 from Horiba.

The 50 and 99.5 percentiles or “centiles” (D₅₀ and D_{99.5} respectively) are the sizes of grains corresponding to the percentages, by weight, of 50% and 99.5% respectively, on the cumulative particle size distribution curve of the sizes of grains of the powder, the sizes of grains being classified by increasing order. For example, 50%, by weight, of the grains of the powder have a size of less than D₅₀ and 50% of the grains, by weight, have a size of greater than D₅₀. The percentiles can be determined using a particle size distribution produced using a laser particle sizer.

The term “maximum size of the grains of a powder” refers to the 99.5 percentile (D_{99.5}) of said powder.

The term “median size of the grains of a powder” or “median diameter” refers to the 50 percentile (D₅₀) of said powder.

The term “impurities” is understood to mean the inevitable constituents introduced, unintentionally and unavoidably, with the starting materials or which result from reactions with these constituents. The impurities are not necessary constituents but only tolerated constituents. For example, the compounds forming part of the group of the oxides, nitrides, oxynitrides, carbides, oxycarbides, carbonitrides and metal entities of sodium and other alkali metals, iron, vanadium and chromium are impurities if their presence is not desired.

When reference is made to “ZrO₂”, there are good grounds for understanding (ZrO₂+HfO₂). This is because a small amount of HfO₂, chemically unseparable from ZrO₂ and exhibiting similar properties, is always naturally present in zirconia sources at contents generally of less than 2%.

The term “Co” and “Ni” is understood to mean cobalt metal and nickel metal.

The term “aspect ratio” R refers to the ratio of the greatest apparent dimension, or “length” L, to the smallest apparent dimension, or “width” W, of a grain. The length and the width of a grain are conventionally measured by the following method. After having withdrawn a representative sample of the grains of the powder, these grains are partially embedded in resin and subjected to a polishing capable of making possible observation as a polished surface. The measurements of the aspect ratio are carried out using images of these polished surfaces, these images being acquired with a Scanning Electron Microscope (SEM), in secondary electrons, with an acceleration voltage of 10 kV and a magnification of ×100 (which represents 1 μm per pixel on the SEM used). These images are preferably acquired in regions where the grains are as well separated as possible, in order to subsequently facilitate the determination of the aspect ratio. The greatest apparent dimension, referred to as length L, and the smallest apparent dimension, referred to as W, are measured of each grain of each image. Preferably, these dimensions are measured using image processing software, such as, for example, Visilog, sold by Noesis. The aspect ratio R=L/W is calculated for each grain. The distribution of the aspect ratio of the powder can subsequently be determined from the combined measurements of aspect ratio R carried out.

Unless otherwise indicated, all the contents of zirconium oxide, of dopant, of nickel and of cobalt of a cermet grain are molar percentages, expressed on the basis of the total molar amount of zirconium oxide, of dopant, of nickel and of cobalt.

Unless otherwise indicated, all the contents of zirconium oxide, of dopant, of nickel oxide and of cobalt oxide of a cermet precursor grain are molar percentages, expressed on the basis of the total molar amount of zirconium oxide, of dopant, of nickel oxide and of cobalt oxide.

### BRIEF DESCRIPTION OF THE FIGURES

Other characteristics and advantages of the invention will become more clearly apparent on reading the description which will follow and on examining the appended drawing, in which:

FIG. 1 diagrammatically represents, in cross section, a solid-oxide fuel cell (SOFC) stack according to the invention;

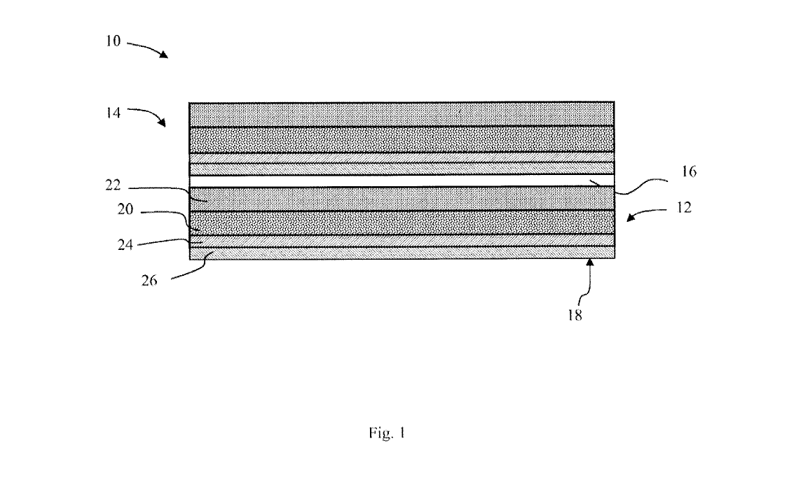

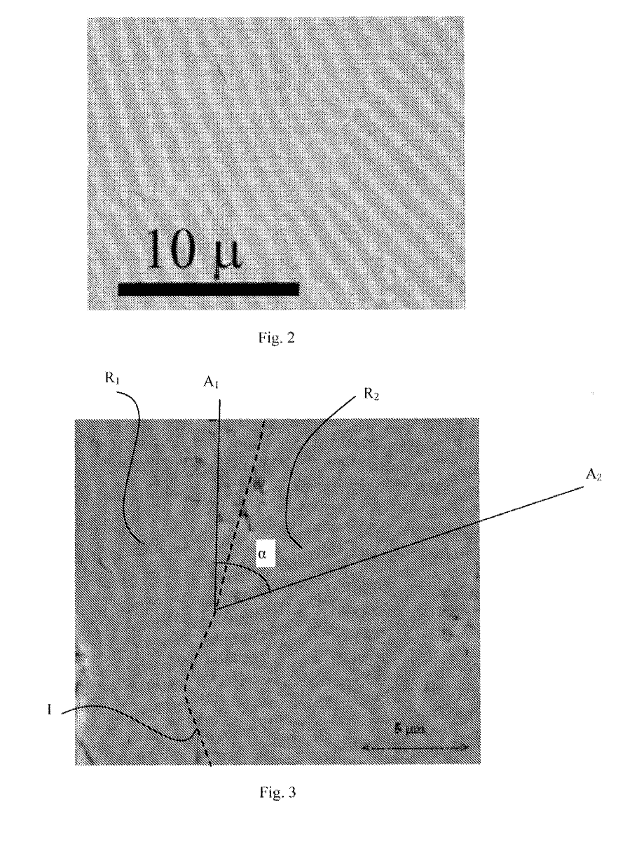

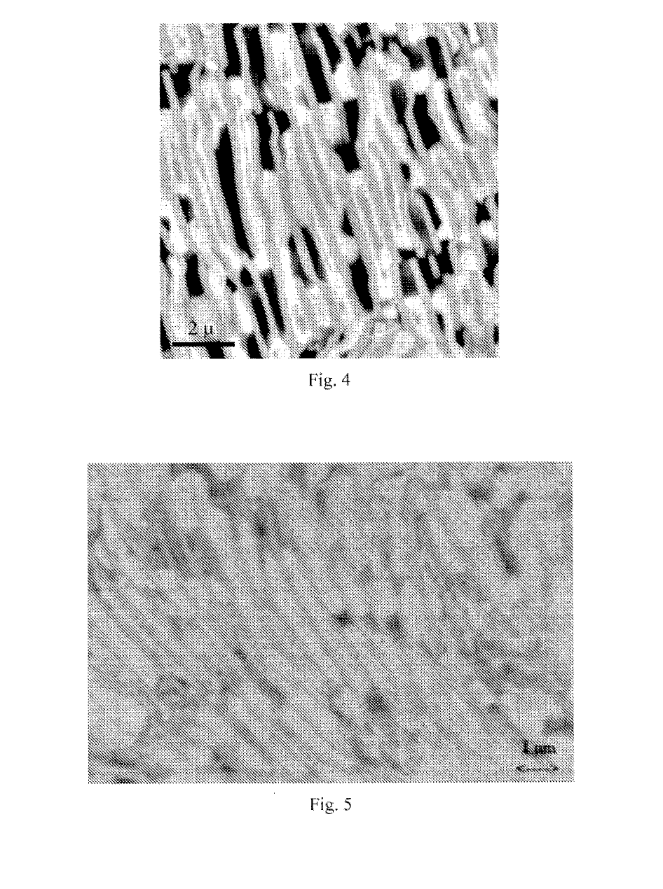

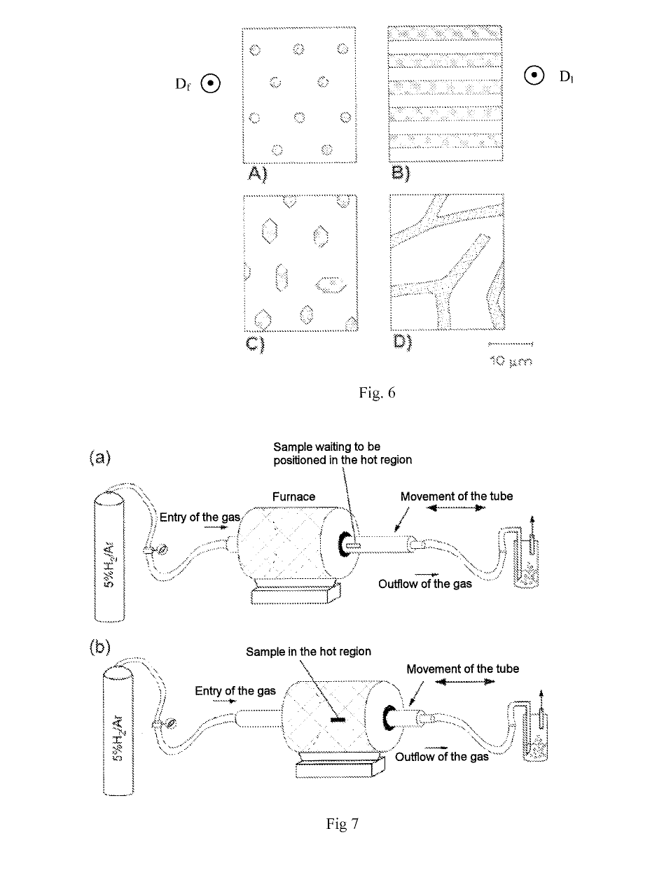

FIGS. 2 to 5 represent photographs, taken using a scanning electron microscope (SEM):
of fused cermet precursors exhibiting a ZrO₂ doped with 16 mol % of yttrium-NiO eutectic structure (FIG. 2) and a ZrO₂ doped with 16 mol % of yttrium-CoO eutectic structure (FIG. 3), these products respectively constituting the grains of the powders of examples 2 and 4 according to the invention;
of fused cermets exhibiting a ZrO₂ doped with 16 mol % of yttrium-Ni eutectic structure (FIG. 4) and a ZrO₂ doped with 16 mol % of yttrium-Co eutectic structure (FIG. 5), these products respectively constituting the grains of the powders of examples 3 and 5 according to the invention;

FIG. 6 represents diagrams illustrating regular eutectic morphologies (FIG. 6A) and 6B)) and irregular eutectic morphologies (FIG. 6C) and 6D));

FIGS. 7(a) and 7(b) represent diagrams illustrating the treatment by reduction carried out for the examples.

In FIG. 2, the zirconium oxide doped with 16 mol % of yttrium appears gray in color and the nickel oxide NiO appears white in color.

In FIG. 3, the zirconium oxide doped with 16 mol % of yttrium appears gray in color and the cobalt oxide CoO appears white in color.

In FIG. 4, the zirconium oxide doped with 16 mol % of yttrium appears gray in color, the nickel Ni appears white in color and the pores appear black in color.

In FIG. 5, the zirconium oxide doped with 16 mol % of yttrium appears gray in color, the cobalt Co appears white in color and the pores appear black in color.

The changes in orientation in the direction of the lamellae visible in the various FIGS. 2 to 5 are due to the changes in direction of the solidification front (eutectic growth plane).

### DETAILED DESCRIPTION OF AN EMBODIMENT OF THE INVENTION

The invention relates to a process for the general manufacture of a cermet precursor powder according to the invention or of a cermet powder according to the invention, comprising the following successive stages:
a) mixing particulate starting materials introducing
   ZrO₂, CoO and/or NiO, and/or one or more precursors of these oxides, and
   a dopant for the zirconium oxide chosen from yttrium, scandium, mixtures of scandium, on the one hand, and of aluminum and/or of cerium, on the other hand, and/or one or more precursors of this dopant, to form a feedstock,
b) melting the feedstock until a molten material is obtained,
c) cooling until said molten material has completely solidified, so as to obtain a fused product exhibiting a eutectic structure,
d) grinding said fused product, so as to obtain a powder,
e) optionally reducing said powder, in order to increase the amount of CoO and/or NiO converted into Co and/or Ni,
   the starting materials being chosen so that, on completion of stage d), the powder obtained is a powder formed of cermet grains or of cermet precursor grains according to the invention.

The cermet preferably exhibits a composition such that:

0.250×Ni+0.176×Co≦(ZrO₂+dopant)≦0.428×Ni+0.333×Co,

the contents being expressed as molar percentages, on the basis of the total molar amount of zirconium oxide, of dopant, of nickel and of cobalt.

The fused cermet precursor preferably exhibits a composition such that:

0.250×NiO+0.176×CoO≦(ZrO₂+dopant)≦0.428×NiO+0.333×CoO,

the contents being expressed as molar percentages, on the basis of the total molar amount of the dopant and of the ZrO₂, CoO and NiO oxides.

Conventional melting processes thus make it possible to manufacture fused products made of cermet precursor or made of a cermet having different sizes, for example in the form of grains or of blocks. The nature of the product obtained (cermet precursor or cermet) depends on the oxidation/reduction conditions encountered during the implementation of the manufacturing process. In particular, a stage e) increases the amount of cermet.

In stage a), the feedstock can be adjusted in order for the process to result, on conclusion of stage d) or e), in a cermet powder or cermet precursor powder according to the invention optionally exhibiting one or more of the optional characteristics described above.

The dopant can be added separately from the zirconium oxide to the feedstock. It is also possible to add doped zirconium oxide to the feedstock.

The oxides ZrO₂, CoO and/or NiO, their precursors, the dopants of the zirconium oxide and their precursors preferably constitute, with the impurities, 100% of the feedstock. Preferably, the impurities are such that, as molar percentages on the basis of the oxides of the feedstock:
CeO₂<0.5%, when the dopant is not a mixture of scandium and of aluminum and/or of cerium, and/or
Na₂O<0.3% and/or
Fe₂O₃<0.2% and/or
Al₂O₃<0.3%, when the dopant is not a mixture of scandium and of aluminum and/or of cerium, and/or
TiO₂<0.3% and/or
CaO<0.2% and/or
MgO<0.2%.

In stage b), use may in particular be made of an induction furnace, a plasma torch, an arc furnace or a laser.

In stage b), the melting is preferably carried out under oxidizing conditions. The oxidizing conditions in stage b) can be maintained in stage c).

As explained in the introduction, the substantially perfect regularity of the eutectic structure resulting from laser floating-zone melting (all the lamellae being substantially parallel to one another) is not essential.

In section, as represented in FIG. 3, a cermet grain or cermet precursor grain according to the invention can thus exhibit first and second networks of parallel lamellae, R₁ and R₂ respectively, the lamellae of the first network and of the second network being oriented, at interface I between the first and second network, along axes A₁ and A₂ respectively, separated from one another by an angle α of more than 10°, indeed even of more than 20°, more than 45° or more than 60°. The structure then locally exhibits a favored orientation (within a network of lamellae). On a larger scale, the orientation of the lamellae is variable, like the furrows of a fingerprint. This type of eutectic structure, regarded as regular, thus does not exhibit a favored general orientation.

The good results obtained with these regular eutectic structures devoid of a favored general orientation make it possible to envisage, in stage c), employing much simpler and more effective manufacturing processes than a laser floating-zone melting method, even if the latter can also be used, in particular under the conditions described in the abovementioned papers.

In one embodiment, use is made of a process other than a laser floating-zone melting method and in particular of a process such as those described below. Preferably, use is made of an arc furnace or induction furnace. Advantageously, it is thus possible to obtain large amounts of product in an industrial fashion.

Stage c) can be carried out, completely or partially, under oxidizing conditions or under reducing conditions. Under oxidizing conditions, a stage e) is necessary in order to obtain a cermet powder according to the invention. Under reducing conditions, a stage e) can advantageously be optional.

In stage c), the solidification rate determines the structure and in particular, in the case of a lamellar structure, the main distance between two lamellae.

The parallel lamellae can be straight or curved.

The possibility of using powders formed of grains exhibiting a regular eutectic structure without a favored general orientation renders the cooling conditions less critical. In particular, the solidification rate and/or the orientation of the solidification front can be variable from one point to another of the fused product.

The solidification rate can be adjusted in order to manufacture regular eutectic structures. In particular, preferably, it can be greater than 0.1 K/s, preferably greater than 1 K/s. The regularity of the structure is preferred but the invention also relates to powders having grains exhibiting an irregular eutectic structure.

In stage d), the fused product resulting from stage c) is ground in order to facilitate the effectiveness of the subsequent stages. The particle size of the ground product is adjusted according to its destination.

The grinding can be carried out in different types of mills, such as, for example, an air jet mill or a roll mill. When a powder exhibiting grains of elongated shape is desired, a roll mill will preferably be used.

If appropriate, the ground grains are subjected to a particle size selection operation, for example by sieving.

In stage e), the reduction results in a conversion of at least a portion of the oxides NiO and CoO into Ni and Co respectively. To this end, the cermet precursor resulting from stage c) or d) is subjected to a reducing environment. For example, it can be brought into contact with a reducing fluid, such as a hydrogen-comprising gas.

Said reducing fluid preferably comprises at least 4% by volume, preferably at least 20% by volume, indeed even at least 50% by volume, of hydrogen (H₂).

On conclusion of stage e), a cermet powder according to the invention is obtained.

The invention also relates to a first specific manufacturing process comprising the stages a) and b) as described above in the context of the general manufacturing process and denoted, for this first process, “a₁)” and “b₁)” respectively, and a stage c) comprising the following stages:
c₁′) dispersion of the molten material in the form of liquid droplets,
c₁″) solidification of these liquid droplets by contact with a fluid, so as to obtain fused grains of cermet precursor.

By simple adjustment of the composition of the feedstock, conventional dispersion processes, in particular blowing, centrifuging or atomization, thus make it possible to manufacture, from a molten material, grains of cermet precursor according to the invention.

A first specific manufacturing process can also comprise one, indeed even several, of the optional characteristics of the general manufacturing process listed above.

In stage c₁′) and/or in stage c₁″), said molten material and/or said liquid droplets in the course of solidification can be brought into contact with an oxidizing fluid. If, during these stages, neither said molten material nor said liquid droplets in the course of solidification were brought into contact with a reducing fluid, a stage e) is essential in order to obtain a cermet product according to the invention.

On conclusion of stage c), beads made of a cermet precursor are then obtained.

In a particularly advantageous alternative form, in stage c₁′) and/or in stage c₁′), said molten material and/or said liquid droplets in the course of solidification are brought into contact with a reducing fluid, which fluid is preferably identical for stage c₁′) and stage c₁″). Advantageously, stage e) is consequently no longer essential in order to obtain cermet grains. The reducing fluid can comprise at least 4% by volume, preferably at least 20% by volume, indeed even at least 50% by volume, of hydrogen (H₂).

Even when a reducing fluid is used in stage c₁′) and/or in stage c₁″), a stage e) can be envisaged in order to increase the amount of cermet. The reducing fluid used in stage c₁′) and/or in stage c₁″), which is preferably gaseous, can be identical to or different from that optionally used in stage e).

In one embodiment, the dispersion stage c₁′) and the solidification stage c₁″) are substantially simultaneous, the means employed for the dispersion bringing about cooling of the molten material. For example, the dispersion results from blowing gas through the molten material, the temperature of said gas being adjusted to the desired solidification rate.

The time during which the droplets are in contact with the oxidizing or reducing fluid can vary. However, preferably, contact between the droplets in this fluid is maintained until said droplets have completely solidified.

The invention also relates to a second specific manufacturing process comprising the stages a) and b) described above in the context of the general manufacturing process and denoted, for this second specific manufacturing process, “a₂)” and “b₂)” respectively, and a stage c) comprising the following stages:
c₂′) casting said molten material in a mold;
c₂″) solidification of the cast material in the mold by cooling until a block is obtained which is at least partially, indeed even completely, solidified;
c₂′″) demolding of the block.

This second specific manufacturing process can also comprise one, indeed even several, of the optional characteristics of the general manufacturing process which are listed above.

In a specific embodiment, in stage c₂′), use is made of a mold which allows rapid cooling. In particular, it is advantageous to use a mold capable of forming a block in the form of a sheet and preferably a mold as described in U.S. Pat. No. 3,993,119.

In stage c₂′) and/or in stage c₂″) and/or in stage c₂′″) and/or after stage c₂′″), said molten material and/or the cast material in the course of solidification in the mold and/or the demolded block can be brought into contact with on oxidizing fluid. If, during these stages, neither said molten material nor the cast material in the course of solidification in the mold nor the demolded block were brought into contact with a reducing fluid, a stage e) is essential in order to obtain a cermet product according to the invention.

In an advantageous alternative form, in stage c₂′) and/or in stage c₂″) and/or in stage c₂′″) and/or after stage c₂′″), said molten material in the course of casting and/or in the course of solidification and/or the demolded block can be brought into contact, directly or indirectly, with a reducing fluid. The reducing fluid can comprise at least 4% by volume, preferably at least 20% by volume, indeed even at least 50% by volume, of hydrogen (H₂). The operation of bringing into contact with a reducing fluid is particularly effective when the mold is designed to manufacture a block with a thickness of less than 10 mm, indeed even of less than 5 mm, in particular in the form of a sheet.

The reducing fluid used in stage c₂′) and/or in stage c₂″) and/or in stage c₂′″) and/or after stage c₂′″), which is preferably gaseous, can be identical to or different from that optionally used in stage e).

Even when a reducing fluid is used in stage c₂′) and/or in stage c₂″) and/or in stage c₂′″) and/or after stage c₂′″), a stage e) is generally preferable in order to increase the amount of cermet, in particular during the manufacture of a bulk block. The reducing fluid used in stage c₂′) and/or in stage c₂″) and/or in stage c₂′″) and/or after stage c₂′″), which is preferably gaseous, can then be identical to or different from that optionally used in stage e).

Preferably, the said operation of bringing into contact with the oxidizing fluid or the reducing fluid begins right from the casting of the molten material in the mold and up to demolding of the block. Preferably again, said contacting operation is maintained until the block has completely solidified.

In stage c₂″), the solidification rates of the molten material during the cooling can in particular always be less than 1000 K/s, less than 100 K/s, less than 50 K/s. In the case where a lamellar structure is desired, the solidification rate is preferably greater than 0.1 K/s, preferably greater than 1 K/s.

In stage c₂′″), the demolding is preferably carried out before complete solidification of the block. Preferably, the block is demolded as soon as it exhibits sufficient rigidity to substantially retain its shape. The effect of contacting with the oxidizing fluid or reducing fluid is then increased.

The first and second specific processes are industrial processes which make it possible to manufacture large amounts of products, with good yields.

Of course, other processes than those described above might be envisaged in order to manufacture a cermet precursor powder or cermet powder according to the invention.

A cermet powder according to the invention can be used in particular to manufacture a porous product according to the invention, in particular a porous anode and a porous anode functional layer, for example by a process comprising the following successive stages:
A) preparation of a cermet powder according to the invention or of a cermet precursor powder according to the invention;
B) shaping the powder prepared in stage A);
C) sintering said powder thus shaped;
D) optionally reduction heat treatment.

The cermet powder used in stage A) can in particular be manufactured according to stages a) to e) described above.

In stage A), preferably, the cermet powder according to the invention or the cermet precursor powder according to the invention comprises more than 70%, more than 80%, more than 90%, more than 95%, more than 98%, indeed even substantially 100%, of cermet grains or cermet precursor grains according to the invention, as percentage by weight, the remainder to 100% preferably being composed of impurities.

Preferably, the cermet powder according to the invention or the cermet precursor powder according to the invention comprises, without considering the optional dopant, less than 5%, preferably less than 1%, as percentage by weight, on the basis of said cermet powder or said cermet precursor powder respectively, of constituent capable of reacting, during stages C) and/or D), with the optionally doped zirconia and/or with nickel oxide and/or with cobalt oxide, and/or with nickel and/or with cobalt, and in particular with the zirconia and/or the nickel and/or the cobalt of the cermet grains according to the invention or with the zirconia and/or the nickel oxide and/or the cobalt oxide of the cermet precursor grains according to the invention. Preferably, the cermet powder according to the invention or the cermet precursor powder according to the invention is substantially devoid of such constituents.

The porous product obtained on conclusion of stage C) or of stage D) can thus comprise more than 70%, more than 80%, more than 90%, more than 95%, more than 98%, indeed even substantially 100%, of cermet grains according to the invention, as a percentage by weight. Furthermore, the cermet grains according to the invention in this porous product can advantageously be composed, for more than 80% of their weight, more than 90% of their weight, more than 95% of their weight, indeed even substantially 100% of their weight, of eutectic structure material.

Advantageously, surprisingly, the inventors have found that such a porous product exhibits a porosity which is particularly stable thermally.

In stage B), the powder can be given any shape, a deposit in the form of a layer being possible.

In stage C), the shaped powder is sintered, according to conventional sintering techniques, for example by hot pressing. In particular, the sintering can be carried out in an oxidizing atmosphere, for example under air, if the powder is a cermet precursor powder.

In stage D), which is optional, the sintered powder is heat treated in a reducing environment, which makes it possible to use, in stage A), a cermet precursor powder according to the invention.

Preferably, the cermet precursor powder is used in stage A) and the manufacturing process comprises a stage C) as sintering under air and a stage D) of heat treatment in a reducing environment.

The porous product according to the invention can exhibit a high total porosity typically of greater than 20% and/or of less than 60%. The total porosity results from the intragranular porosity and from the intragranular porosity created during the sintering.

### EXAMPLES

The following nonlimiting examples are given with the aim of illustrating the invention.

The product of comparative example 1, which is provided in the form of a sheet, was obtained by laser floating zone melting using a CO₂ laser with a power of 600 watts.

The starting materials used are as follows:
a nickel oxide NiO powder exhibiting a median diameter of approximately 1 μm and obtained by grinding, in a micromill comprising zirconia beads with a diameter of 1 mm and in 2-propanol, a powder sold by Alfa Aesar, with a particle size of −325 mesh and with a purity of greater than 99.99%, followed by drying at 70° C. for 10 hours;
a powder formed of zirconium oxide doped with 16 mol % of yttrium, sold by Tosoh under the name 8YSZ, with a median diameter equal to 0.25 μm and with a purity equal to 99.9%.

The powdered starting materials are chosen and their amounts adjusted as a function of a product to be manufactured.

The starting materials are intimately mixed in acetone. The suspension is stirred for 1 hour. The suspension is subsequently deagglomerated using ultrasound, in eight cycles each of 2 minutes, and then dried at 70° C. for 12 hours.

The mixture thus obtained is pressed in the form of a sheet.

The sheet obtained is subsequently sintered under air in the following way:
Rise from ambient temperature to 400° C. at 1° C./min;
Stationary phase at 400° C. for 6 hours;
Rise from 400° C. to 1300° C. at 4° C./min;
Stationary phase at 1300° C. for 12 hours;
Rise from 1300° C. to 1450° C. at 4° C./min;
Stationary phase at 1450° C. for 0.5 hour;
Fall to ambient temperature at 2° C./min.

The sheet thus sintered is subsequently moved in translation (without rotation) through the beam of a laser adjusted to 50 W. It is thus subjected to laser floating zone melting over its upper part, with a constant growth rate of 500 mm/h, which corresponds to a solidification rate of 100 K/s.

The sheet thus obtained is reduced according to the protocol described below:

A quartz tube with an approximate length of 100 cm and with an internal diameter equal to 3 cm is introduced into a tubular furnace at rest. The quartz tube is longer than the furnace, in order to make possible movement of the tube in the furnace, according to the principle described in FIG. 7. A reducing gas mixture consisting of 4 vol % of hydrogen (H₂) and 96 vol % of nitrogen (N₂) is made to flow through the quartz tube with a flow rate of 0.7 liter/minute, in order to remove any trace of oxygen. The furnace is subsequently brought to 850° C. (rise in temperature of approximately 10° C./min). The sheet, weighed beforehand, is subsequently introduced into the quartz tube (FIG. 7(a)), and the quartz tube is moved along the furnace in order to make it possible to position the sheet to be treated in the hot region of the furnace for 3.5 hours (FIG. 7(b)).

The sheet thus obtained is subjected, after cooling, to a rectification stage which consists in removing the portion of the sheet which was not melted by the laser. After rectification, a cermet sheet with a thickness of 500 μm is obtained.

The product of example 2 according to the invention was obtained by laser floating zone melting using a CO₂ laser with a power of 600 watts, ground and sieved.

The starting materials used are as follows:
a nickel oxide NiO powder exhibiting a median diameter of approximately 1 μm and obtained by grinding, in a micromill comprising zirconia beads and in 2-propanol, a powder sold by Alfa Aesar, with a particle size of −325 mesh and with a purity of greater than 99.99%, followed by drying at 70° C. for 10 hours;
a powder formed as zirconium oxide doped with 16 mol % of yttrium, sold by Tosoh under the name 8YSZ, with a median diameter equal to 0.25 μm and with a purity equal to 99.9%.

The powdered starting materials are chosen and their amounts adjusted as a function of the product to be manufactured.

The starting materials are intimately mixed in acetone. The suspension is stirred for 1 hour. The suspension is subsequently deagglomerated using ultrasound, in eight cycles each of 2 minutes, and then dried at 70° C. for 12 hours.

The mixture thus obtained is shaped into rods by cold isostatic pressing (CIP) at 175 MPa for 5 minutes.

The rods obtained are subsequently sintered under air in the following way:
Rise from ambient temperature to 400° C. at 1° C./min;
Stationary phase at 400° C. for 6 hours;
Rise from 400° C. to 1350° C. at 4° C./min;
Stationary phase at 1350° C. for 2 hours;
Fall to ambient temperature at 2° C./min.

The rods thus sintered are subsequently moved in translation (without rotation of the rods) through the beam of a laser adjusted to 50 W. They are thus subjected to laser floating zone melting with a constant growth rate of between 10 and 3500 mm/h, which corresponds to a solidification rate of between 2 and approximately 700 K/s.

For example 2, after floating zone solidification, the product from the rods is ground and sieved in order to obtain a powder formed of cermet precursor grains according to the invention.

For example 3, a rod from example 2 was reduced according to the protocol described below:

A quartz tube with an approximate length of 100 cm and with an internal diameter equal to 3 cm is introduced into a tubular furnace at rest. The quartz tube is longer than the furnace, in order to make possible movement of the tube in the furnace, according to the principle described in FIG. 7. A reducing gas mixture consisting of 4 vol % of hydrogen (H₂) and 96 vol % of argon (Ar) is made to flow through the quartz tube with a flow rate of 0.7 liter/minute, in order to remove any trace of oxygen. The furnace is subsequently brought to 750° C. (rise in temperature of approximately 10° C./min). The rod, weighed beforehand, is subsequently introduced into the quartz tube (FIG. 7(a)), and the quartz tube is moved along the furnace in order to make it possible to position the rod to be treated in the hot region of the furnace for 1 hour (FIG. 7(b)). The quartz tube is subsequently moved so that the rod is outside the furnace. The rod is then extracted from the tube and weighed. The rod is subsequently placed back in the quartz tube and is subjected to a new heat treatment under the reducing gas mixture as described above until the weight of the rod no longer changes between two treatments.

The rod is subsequently ground and sieved in order to obtain a powder formed of cermet grains according to the invention.

The product of example 4 was obtained by melting in an arc furnace.

The starting materials used are as follows:
a cobalt oxide Co₃O₄ powder comprising 71-72% by weight of cobalt, sold by Altichem, more than 96% of the grains of which exhibit a size of less than 45 μm;
a zirconium oxide powder, with a purity equal to 99.65% and with a median diameter between 4 and 5 μm, sold under the name CZ-5 by Saint-Gobain Zirpro;
an yttrium oxide powder, with a purity of greater than 99%, sold by Treibacher Industrie A.G. under the name Yttrium Oxide 99.99%.

A feedstock produced by mixing said starting materials was melted in a single-phase electric arc furnace of Héroult type comprising graphite electrodes, with a graphite vessel having a capacity of 3 liters, a voltage of 65 to 70 V, a current of 400 A and a specific electrical energy supplied of 1230 kWh/T charged. The preparation conditions were oxidizing. When melting is carried out, the molten liquid is poured so as to form a thin stream. Blowing with dry compressed air at a pressure of 5 bar breaks up the thin stream and disperses the molten liquid as droplets.

The blowing cools these droplets and congeals them in the form of fused particles with a size of between 0.01 and 3 mm. The cooling rate is a function of the size of the particle. It is approximately 1000 K/s for particles of the size 0.3 mm. These particles are subsequently ground using a roll mill and sieved, so as to obtain a powder formed of cermet precursor grains according to the invention.

The product of example 5 was obtained by reducing the powder of example 4 according to the protocol described below:

Approximately 1 kg of powder according to example 4 is introduced into a sealed muffle made of sintered alumina of cylindrical shape, with a length of 300 mm and a diameter of 100 mm, placed in a Heraeus K18 electric furnace. A reducing gas mixture consisting of 10 vol % of hydrogen (H₂) and 90 vol % of argon (Ar) is made to flow through the quartz tube with a flow rate of 3 liters/minute in order to remove any trace of oxygen. The furnace is subsequently brought to 1000° C. (rise in temperature of approximately 300° C./h) for a time of 12 hours. After cooling, a powder formed of cermet grains according to the invention is obtained.

In the different examples, the contents of impurities were less than 2%.

The results are summarized in the following table 1:

TABLE 1

| | | | | | | | Solidification | |
|---|---|---|---|---|---|---|---|---|
| | | | | | | | rate during the | |
| | | Mol % ZrO₂ | | | Mol % doped | Mol % doped | manufacture of | |
| | | doped to | Mol % | Mol % | ZrO₂/mol % | ZrO₂/mol % | the fused cermet | |
| Ex. | Product | 16 mol % Y | Co | Ni | Co | Ni | precursor (K/s) | Structure |
| 1(*) | Sheet formed of | 25 | | 75 | | 0.333 | 100 | lamellar |
| | ZrO₂ doped with | | | | | | | |
| | yttrium:Ni cermet | | | | | | | |
| 2 | Powder formed of | 25 | | 75 | | 0.333 | 20 | lamellar |
| | ZrO₂ doped with | | | | | | | |
| | yttrium:NiO cermet | | | | | | | |
| | precursor grains | | | | | | | |
| 3 | Powder formed of | 25 | | 75 | | 0.333 | | lamellar |
| | ZrO₂ doped with | | | | | | | |
| | yttrium:Ni cermet | | | | | | | |
| | grains | | | | | | | |
| 4 | Powder formed of | 20.5 | 79.5 | | 0.258 | — | >1 K/s | lamellar |
| | ZrO₂ doped with | | | | | | | |
| | yttrium:CoO cermet | | | | | | | |
| | precursor grains | | | | | | | |
| 5 | Powder formed of | 20.5 | 79.5 | | 0.258 | | | lamellar |
| | ZrO₂ doped with | | | | | | | |
| | yttrium:Co cermet | | | | | | | |
| | grains | | | | | | | |

Disks with a diameter of 28 mm and a thickness of 2 mm were subsequently produced from the powder of example 2 (powder according to the invention) by cold uniaxial pressing at a pressure of 69 MPa. The discs thus obtained were subsequently subjected to hot pressing under air at 1280° C., with a maximum pressure of 12 MPa applied for 30 minutes.

The disks were subsequently subjected to a reduction according to the protocol described for the powder of example 5.

The disks obtained do not exhibit visible cracks.

The powders according to the invention thus make possible the manufacture of parts made of cermet having a eutectic structure which are of various shapes and which do not exhibit cracks. These parts have proved to be well suited to the manufacture of anodes of SOFC fuel cell stacks.

Measurement of the Stability of the Porosity

Five samples are taken at random from each rod of comparative example 1 and example 3 according to the invention.

Each rod is subsequently subjected to the following aging treatment: a quartz tube with an approximate length of 100 cm and an internal diameter equal to 3 cm is introduced into a tubular furnace at rest. The quartz tube is longer than the furnace, in order to make possible movement of the tube in the furnace, according to the principle illustrated in FIG. 7. A reducing gas mixture consisting of 4.8 vol % of hydrogen (H₂), 3 vol % of water (H₂O) and 92.2 vol % of argon (Ar) is made to flow through the quartz tube with a flow rate of 0.4 liter/minute in order to remove any trace of oxygen. The furnace is subsequently brought to 850° C. (rise in temperature of approximately 10° C./min). The rod is subsequently introduced into the quartz tube and the quartz tube is moved along in the furnace in order to make it possible to position the rod to be treated in the hot region of the furnace for 600 hours. The quartz tube is subsequently moved so that the rod is outside the furnace and then the rod is extracted from the tube in order to be analyzed.

Five other samples are then taken at random, from the rod obtained, in order to be compared with the samples of the same rod taken before the aging treatment.

For each rod, a distribution of the pores, by number, is measured before and after aging by mercury porosimetry using a Poremaster® 33 porosimeter from Quantachrome Instruments.

These distributions are evaluated cumulatively over the five samples taken from this rod, before and after aging, respectively.

For example, the number distribution of the pores before the aging treatment on the rod of comparative example 1 is the sum of the distribution of the pores measured on each of the five samples taken from this rod before the aging treatment.

By definition, 50% by number of the pores exhibit a pore size which is less than the median diameter D₅₀.

The percentage of increase in the median diameter D₅₀ is defined by the following formula:

[(D₅₀ after aging treatment)−(D₅₀ before aging treatment)]/(D₅₀ before aging treatment).

The results obtained are summarized in table 2.

TABLE 2

| | D₅₀ before aging | D₅₀ after aging | % of increase in |
|---|---|---|---|
| | treatment (μm) | treatment (μm) | the D₅₀ |
| Comparative example 1 | 0.456 | 0.609 | 33.6 |
| Example 3 | 0.245 | 0.277 | 13.1 |

The measurements show a change in the porosity which is markedly smaller with regard to the example according to the invention than with regard to the comparative example.

Surprisingly, the inventors have thus demonstrated that a product according to the invention exhibits a greater stability of the porosity over time.

Of course, the present invention is not limited to the embodiments described, which are provided by way of illustration.

1. A powder formed of grains, said grains comprising:
a fused cermet formed of zirconium oxide ZrO₂ doped with a dopant chosen from yttrium, scandium, a mixture of scandium and of aluminum and/or of cerium, and of nickel Ni and/or of cobalt Co, the contents of zirconium oxide, of dopant, of nickel and of cobalt, as molar percentages on the basis of the total molar amount of zirconium oxide, of dopant, of nickel and of cobalt, being such that:
0.250×Ni+0.176×Co≦(ZrO₂+dopant)≦0.428×Ni+0.333×Co, and/or
a precursor of said fused cermet,
said cermet and/or precursor exhibiting a eutectic structure and said powder exhibiting a median diameter D₅₀ of between 0.3 μm and 100 μm.

2. The powder as claimed claim 1, in which the cermet does not comprise nickel and is such that, as molar percentages, for a total, excluding impurities, of 100%,
(ZrO₂+dopant): 15%-25%
Co: 75%-85%.

3. The powder as claimed in claim 1, in which the cermet does not comprise cobalt and is such that, as molar percentages, for a total, excluding impurities, of 100%,
(ZrO₂+dopant): 20%-30%
Ni: 70%-80%.

4. The powder as claimed in claim 1, in which the molar content of dopant of the zirconium oxide ZrO₂, on the basis of the sum of the molar contents of zirconium cations and of dopant cations, is greater than 14% and less than 25%.

5. The powder as claimed in claim 1, in which:
the zirconium oxide ZrO₂ is doped only with yttrium, the molar content of yttrium cations, on the basis of the sum of the molar contents of zirconium cations and of yttrium cations, being greater than 14% and less than 22%, or
the zirconium oxide ZrO₂ is doped only with scandium, the molar content of scandium cations, on the basis of the sum of the molar contents of zirconium cations and of scandium cations, being greater than 14% and less than 22%, or
the zirconium oxide ZrO₂ is doped only with a mixture of scandium and of cerium, the molar content of scandium cations, on the basis of the sum of the molar contents of zirconium cations, of scandium cations and of cerium cations, being greater than 14% and less than 22%, and the molar content of cerium cations, on the basis of the molar contents of zirconium cations, of scandium cations and of cerium cations, being greater than 0.5% and less than 1.5%, or
the zirconium oxide ZrO₂ is doped only with a mixture of scandium and of aluminum, the molar content of scandium cations, on the basis of the sum of the molar contents of zirconium cations, of scandium cations and of aluminum cations, being greater than 14% and less than 22%, and the molar content of aluminum cations, on the basis of the molar contents of zirconium cations, of scandium cations and of aluminum cations, being greater than 1% and less than 3%.

6. The powder as claimed in claim 5, in which the molar content of yttrium cations, on the basis of the sum of the molar contents of zirconium cations and of yttrium cations, is greater than 15% and less than 21%.

7. The powder as claimed in claim 1, in which the dopant is yttrium.

8. The powder as claimed in claim 1, exhibiting a median diameter of greater than 0.5 μm and less than 4 μm, or greater than 10 μm and less than 50 μm.

9. The powder as claimed claim 1, exhibiting a lamellar structure, the mean distance between two lamellae being greater than 0.2 μm and less than 6 μm.

10. The powder as claimed in claim 1, exhibiting a lamellar structure without favored general orientation.

11. The powder as claimed in claim 1, in which said eutectic structure is irregular.

12. The powder as claimed in claim 1, the cermet grains comprising more than 80% of said cermet, as percentage by weight.

13. The powder as claimed in claim 1, comprising more than 80% of said grains, as percentage by weight.

14. A sintered product formed from a powder as claimed in claim 1, said sintered product exhibiting a total porosity of greater than 20%.

15. The sintered product as claimed in claim 14, the cermet powder and/or cermet precursor powder representing more than 80% of the weight of the sintered product.

16. An electrode comprising a region made of a sintered product as claimed in claim 14.

17. A solid-oxide fuel cell stack comprising an electrode as claimed in claim 16.

18. A manufacturing process comprising the following successive stages:
a) mixing particulate starting materials introducing
ZrO₂, CoO and/or NiO, and/or one or more precursors of these oxides, and
a dopant for the zirconium oxide chosen from yttrium, scandium, mixtures of scandium, on the one hand, and of aluminum and/or of cerium, on the other hand, and/or one or more precursors of this dopant,
to form a feedstock,
b) melting the feedstock until a molten material is obtained,
c) cooling until said molten material has completely solidified, so as to obtain a fused product,
d) grinding said fused product, so as to obtain a powder,
e) optionally reducing said powder,
the starting materials being chosen and the cooling in stage c) comprising an operation in which the molten material in the course of cooling and/or the fused product is brought into contact with a reducing fluid so that, on conclusion of stage d), the powder obtained is a fused cermet powder as claimed in claim 1.
